(19) United States
(12) Patent Application Publication
(10) Pub. No.: US 2013/0081659 A1
(43) Pub. Date: Apr. 4, 2013

(54) CLEANING OF OIL-IN-WATER MONITORS

(71) Applicants: Per Gerhard Grini, Trondheim (NO); Harald Kallevik, Flatasen (NO)

(72) Inventors: Per Gerhard Grini, Trondheim (NO); Harald Kallevik, Flatasen (NO)

(73) Assignee: Statoil Petroleum AS, Stavanger (NO)

(21) Appl. No.: 13/252,539

(22) Filed: Oct. 4, 2011

(51) Int. Cl. B08B 3/08; B08B 3/00

(52) U.S. Cl. 134/34; 134/172; 134/184; 134/198

(57) ABSTRACT

An oil-in-water monitor cleaning apparatus includes a nozzle configured to direct pressurized cleaning fluid at an optical window.

### TECHNICAL FIELD

The disclosure generally relates to cleaning of oil-in-water monitors.

### BACKGROUND

Oil-in-water monitors are able to detect small quantities of oil suspended in water. Oil-in-water monitors may, for example, be used for detecting the level of oil in produced water from oil-water separation on petroleum production. This water can either be discharged to sea, or injected into a reservoir of other underground formation. For subsea processing of hydrocarbons, it is very important to have a reliable oil-in-water instrument to measure oil content in the water, which is separated from oil and which is to be re-injected into a well, does not contain too much oil as this can lead to clogging of the injection well. Of course, it is also not desirable to dispose of oil in this way. If the water is intended for subsea discharge to sea, exact measurement of the oil content is even more important.

Oil-in-water monitors are commercially available. These monitors have shown good results for topside use, which is use on a platform above the water, both for process optimization and for monitoring the quality of the water being discharged to sea.

The largest problem with these meters is that most of them rely on a window where various optical signals pass through. The window is placed between the instrument and the flowing stream, and is therefore exposed to all the constituents in this stream. Therefore, this window will get dirty after some operational time, and the window needs to be cleaned in some way to continue operation in a reliable way.

Various principles have been tried for cleaning the optical window and ultrasound cleaning has worked well for cleaning the equipment on platform applications where the pressure is usually low. But when the pressure is above approx 25 bar the ultrasound technology is not working properly and therefore cleaning in a sub-sea application requires a different solution.

No proper cleaning technology has to our knowledge been found, and this prevents reliable subsea use of this important instrument.

### SUMMARY

It is an object of the present invention to provide a reliable subsea cleaning technology.

According to a first aspect of the invention, there is provided an oil-in-water monitor cleaning apparatus comprising a nozzle configured to direct pressurised cleaning fluid at an optical window.

The fluid may be methanol, ethanol, glycol, toluene, or fluid from a well.

The device may further comprise a pressure pump. The device may further comprise a sub-sea template. The device may further comprise an umbilical line to a platform. The oil-in-water analytical instrument may be used in oil exploration. The oil-in-water analytical instrument may be used in an oil recovery application. The oil-in-water analytical instrument may be used in an oil subsea processing application. The pressurised cleaning fluid may be directed at the optical window at an angle and the angle can be varied.

According to a second aspect of the invention, there is provided a method comprising cleaning a window of an oil-in-water monitor by directing pressurised cleaning fluid at an optical window of the oil-in-water monitor.

The fluid may be methanol, ethanol, glycol, toluene, or fluid from a well.

### BRIEF DESCRIPTION OF THE DRAWINGS

FIG. 1 shows an example of a cleaning apparatus.

### DETAILED DESCRIPTION

A washing technology for cleaning the lens or optical window of an oil-in-water monitor is proposed. The washing technology may be used for monitors both for platform and subsea use.

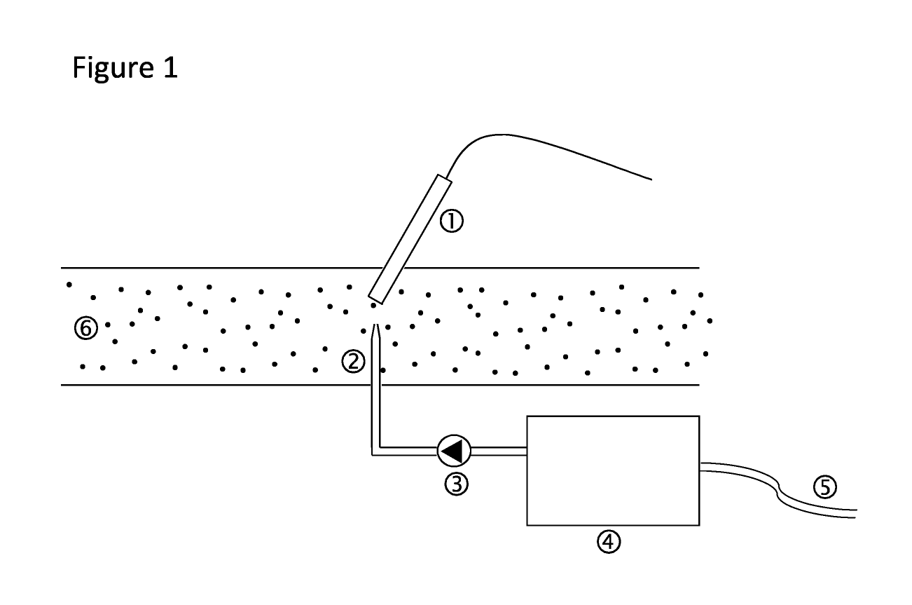

FIG. 1 shows an example of the cleaning apparatus. A monitor 1 is located inside a pipe 6 containing water flow in which oil may be suspended. The water may be produced for re-injection into a well, for further processing or for disposal to the sea. The monitor has an optical window located inside the pipe. Near the window of the monitor a nozzle 2 is suspended for jetting fluid onto the window. The fluid inside the nozzle has a positive pressure with respect to the surrounding water. A pump 3 may be used to provide positive pressure inside the nozzle. A subsea template 4 is provided to which all other components in the figure might be attached. An umbilical 5 may be required for transporting fluids and power from a platform to the subsea template. A subsea template is a large subsea structure resting on the sea bed which may be used as a base supporting wellheads, subsea trees and equipment and may be covered by a protective structure. The nozzle 2 is directed at the monitor 1 such that the cleaning fluid is directed at the optical window at an angle. The angle under which the cleaning fluid is directed the window is variable by changing the relative orientation of the nozzle and optical window.

Several different fluids may be used for cleaning the optical window.

Methanol may be used as cleaning fluid. The advantage of using methanol is that it may already be available at the subsea template for other purposes than cleaning such as hydrate inhibition. A pump 3 may still be required to provide a positive pressure sufficiently big to jet wash the optical window.

Glycol (MEG) may be an alternative fluid to Methanol. MEG may also be available at the template for preventing the formation of hydrates.

Toluene is a further option for cleaning fluid. Toluene is generally not already present at a subsea template for other purposes and must therefore be transported from a platform to the location of the cleaning apparatus, such as the wellhead, through a line in the umbilical. A new chemical supply system for the host platform may also need to be made. Toluene is in general an effective cleaning solvent.

A further option for cleaning fluid is using the well-fluid itself as cleaning fluid. The well fluid may be used by running it through the pump and jet nozzle. The well fluid may not be a solvent such as toluene, but a high positive pressure of the well fluid inside the nozzle may be sufficient to remove deposits from the optical window.

The jetting must be performed regularly at given intervals in order to avoid build up of too large/hard deposits. By washing the lens or optical window of the oil-in-water instrument it is kept clean and fouling or deposits will not disturb the measurement of oil-in-water.

It will be appreciated by the person of skill in the art that various modifications may be made to the above described embodiments without departing from the scope of the present invention.

1. A system comprising:
an oil-in-water monitor comprising an optical window; and
a cleaning apparatus comprising a nozzle configured to direct pressurized cleaning fluid at the optical window.

2. The system according to claim 1, wherein the fluid is methanol.

3. The system according to claim 1, wherein the fluid is ethanol.

4. The system according to claim 1, wherein the fluid is glycol.

5. The system according to claim 1, wherein the fluid is toluene.

6. The system according to claim 1, wherein the fluid is fluid from a well.

7. The system according to claim 1, wherein the device further comprises a pressure pump.

8. The system according to claim 1, wherein the device further comprises a sub-sea template.

9. The system according to claim 1, wherein the device further comprises an umbilical line to a platform.

10. The system according to claim 1, wherein the oil-in-water monitor is used in oil exploration

11. The system according to claim 1, wherein the oil-in-water monitor is used in an oil recovery application.

12. The system according to claim 1, wherein the oil-in-water monitor is used in an oil subsea processing application.

13. (canceled)

14. The system according to claim 13, wherein the angle of the nozzle with respect to the optical window of the oil-in-water monitor can be varied.

15. A method comprising cleaning a window of an oil-in-water monitor by directing pressurized cleaning fluid at the optical window of the oil-in-water monitor.

16. The method according to claim 15, wherein the fluid is methanol.

17. The method according to claim 15, wherein the fluid is ethanol.

18. The method according to claim 15, wherein the fluid is glycol.

19. The method according to claim 15, wherein the fluid is toluene.

20. The method according to claim 15, wherein the fluid is fluid from a well.

21. The method according to claim 15, wherein the pressurized cleaning fluid is directed at the optical window at an angle and wherein the angle can be varied.
